(19) United States
(12) Patent Application Publication
(10) Pub. No.: US 2010/0135105 A1
(43) Pub. Date: Jun. 3, 2010

(54) Apparatus and Method for Monitoring a Cleaning and/or Aeration System

(75) Inventors: Peter Szlama, Jockgrim (DE); Klaus Connrad, Maintal (DE); Wolfgang Bunte, Twistetal (DE)

Correspondence Address: CROWELL & MORING LLP;INTELLECTUAL PROPERTY GROUP, P.O. BOX 14300, WASHINGTON, DC, 20044-4300, US

(73) Assignee: KSB Aktiengesellschaft, Frankenthal (DE)

(21) Appl. No.: 12/622,666

(22) Filed: Nov. 20, 2009

Related U.S. Application Data
(63) Continuation of application No. PCT/EP2008/003641, filed on May 7, 2008.

(30) Foreign Application Priority Data
May 22, 2007 (DE) 10 2007 024 017.3

(51) Int. Cl. B01F 15/00

(52) U.S. Cl. 366/138

(57) ABSTRACT

An apparatus for monitoring and supporting the maintenance of a cleaning and/or aeration system for a device serving to receive and temporarily store contaminated liquid, in which the cleaning system includes one or more assemblies aspirating liquid present in the device and discharging the liquid into the device in the form of a jet or stream, and a method of monitoring and supporting the maintenance of a cleaning and/or aeration system including such a device. One or more measuring devices (1) are disposed in the vicinity of an air intake pipe (8) for monitoring the flow behavior of the liquid.

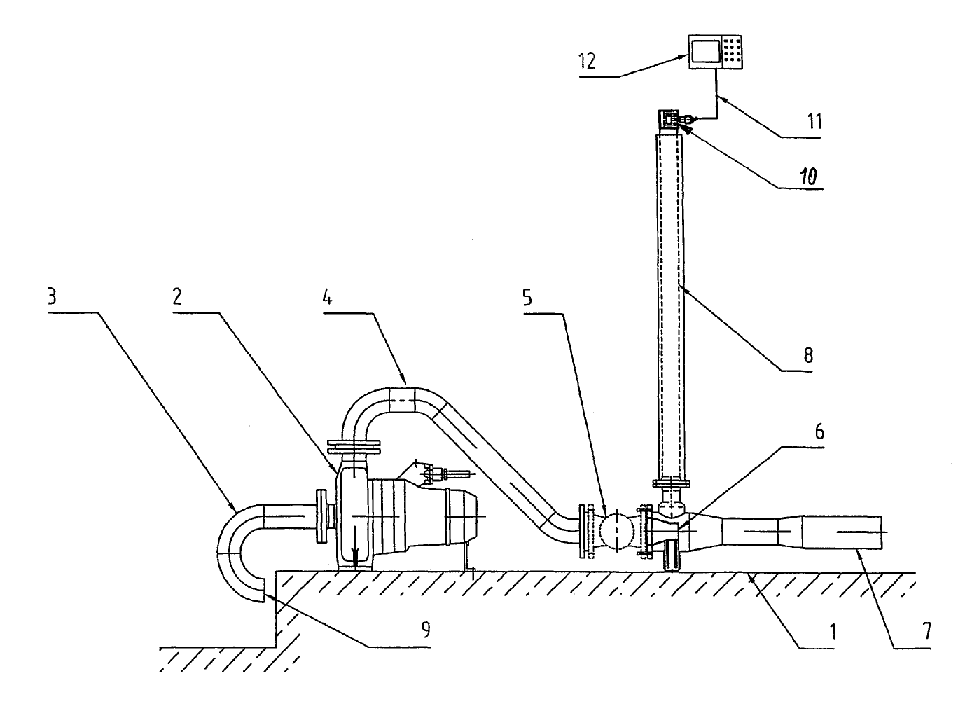

### CROSS REFERENCE TO RELATED APPLICATIONS

This application is a continuation of international patent application No. PCT/EP2008/003641, filed May 7, 2008 designating the United States of America and published in German on Nov. 27, 2008 as WO 2008/141728, the entire disclosure of which is incorporated herein by reference. Priority is claimed based on Federal Republic of Germany patent application No. DE 10 2007 024 017.3, filed May 22, 2007.

### BACKGROUND OF THE INVENTION

The invention relates to an apparatus for monitoring and supporting the maintenance of a cleaning and/or aeration system for a device serving for the reception and temporary storage of contaminated liquid, the cleaning system comprising one or more assemblies which suck up liquid present in the device and discharge it into the device in the form of a jet. The invention further relates to a method for monitoring a cleaning and/or aeration system with such an apparatus.

In addition to systems comprising mixers or agitators, above all such cleaning systems are used which are equipped with pumps which suck up the liquid of the device and feed it back into the device via one or more pipe lines. Pipe line sections equipped with injector nozzles can here also be provided, by which external air is sucked into the feed jet of the centrifugal pump in order thus to achieve an aeration and an improvement of the cleaning performance on the floor of the device.

Cleaning systems of this type are known, inter alia, by virtue of German patent no. DE 199 55 424 C2 and European patent no. EP 1 039 053 B1. They are preferably used in dirty water tanks, rain overflow basins and tank sewers. Since, for the cleaning and aeration, they use the water which is present in the respective device and is contaminated with suspended materials, there is the danger that constrictions in the path of conveyance of the water, i.e. primarily nozzles, may be blocked by adhering dirt particles. The blockage process is generally creeping. Since those parts of the cleaning or aeration system which are at risk of blockage lie beneath the at least temporarily present water level, a check by visual inspection is not always possible. Therefore a blockage is often only recognized once a complete closure has already set in. The result is a total failure of the cleaning system.

Published German patent application No. DE 10 2005 023 269 A1 discloses a method and apparatus for monitoring a cleaning system, in which already impending disturbances can be recognized. To this end, within the liquid stream generated by an assembly, the flow behavior of the liquid is monitored. If the liquid stream is here monitored on the basis of the jet generated by the assembly, where a centrifugal pump is used as the jet discharging assembly, the suction behavior of the centrifugal pump in the intake region, or the flow behavior of the liquid in the pipe lines fed by the centrifugal pump through suction or pressure, is monitored. The measurements within a liquid stream generated by an assembly, as are described there, are susceptible to impurities present in the liquid or harbor the risk of rapid wearing of the sensors used.

### SUMMARY OF THE INVENTION

Accordingly, the object of the invention is to provide an apparatus and a method of the type stated in the introduction, which provides a cost-effective and reliable monitoring of the flow behavior of the liquid.

This and other objects are achieved in accordance with the present invention by providing an arrangement of one or more measuring instruments in the region of an air intake pipe, for monitoring the flow behavior of the liquid. The monitoring of the flow behavior of the liquid within the flow path of the system via measuring instruments disposed on or in the region of the air intake pipe and/or in the surrounds thereof means that lesser demands are placed upon the measuring instruments used.

The measured fluid is generally the sucked-up external air in the air intake pipe. In normal operation, for the generation of a jet, a specific quantity of air is sucked up through the air intake pipe. A change in flow behavior of the air sucked up through the air intake pipe points to an incipient blockage in the region of a constriction of the liquid flow path within the system. The measurement finding is not influenced by impurities or solids present in the flow medium. Furthermore, unlike other locations within the cleaning system, the measuring instruments are not persistently exposed to an abrasive and corrosive liquid, thereby increasing the working life of the measuring instruments.

Alternatively, in systems in which, because of the installation position and the prevailing liquid levels, the suction performance of an injector nozzle is inadequate, the inlet opening of the air intake pipe can be connected to an external air source. In such a case, an influx of air through the air intake pipe to the jet is no longer effected with an underpressure, but with an overpressure relative to an ambient pressure.

The invention not only provides a cost-effective, reliable and early monitoring of blockages in a cleaning system; the invention surprisingly offers the added advantage that, as a result of the measuring instruments disposed on the air intake pipe, the air quantity introduced into the generated liquid-air jet is established. The cleaning system according to the invention thereby makes it possible to determine the degree of aeration of a tank or basin.

In accordance with one embodiment of the invention, one or more measuring instruments monitor and/or measure an air and/or liquid stream present in the air intake pipe. The measuring instruments thus monitor the flow behavior of the liquid by means of the air stream, generated by an assembly, through the air intake pipe. It is additionally provided that the measuring instruments monitor and/or measure a liquid stream present in the air intake pipe. This ensures that, in the event of a flooded air intake pipe and/or in the event of a rise in liquid in the air intake pipe, which occurs with a severe blockage, measurements can nevertheless be made.

It has proved advantageous for the apparatus to have one or more sensors, disposed in or on the air intake pipe, for monitoring and/or measuring an air stream and/or a liquid stream. Such sensors can extend into the air intake pipe or can be otherwise⁻fastened. The sensors have a construction which is liquid-tight, floodable or protected against aggressive liquids, in order also to be functional during temporary or persistent flooding.

It is advantageous if the apparatus has an evaluation unit for detecting various operating states. Such an evaluation unit detects various operating states such as “Satisfactory Throughflow”, “Partial Blockage” and “Operating Disturbance/Blockage”. In addition, a display unit can be used, whereby a check on the state of the system and, above all, a prompt intervention in the event of obtained changes, is possible at all times. Furthermore, the evaluation unit may optionally include a documentation or recording function which stores the respective operating states of a system for a period of time and verifiably registered.

A method of monitoring and supporting the maintenance of a cleaning and/or aeration system of the aforedescribed type provides that the flow behavior of the liquid is monitored by one or more measuring instruments disposed in the vicinity of an air intake pipe. In this case it is advantageous that the measuring instruments monitor and/or measure an air and/or liquid stream present in the air intake pipe.

An evaluation unit detects various operating states such as “Satisfactory Throughflow”, “Partial Blockage” and “Operating Disturbance/Blockage”. In addition, a display unit can display the respective operating state of the system.

A cost-effective method monitors and/or measures an air stream and/or a liquid stream by means of one or more sensors which extend into the air intake pipe.

Alternatively, a method is provided in which an air stream and/or a liquid stream is monitored and/or measured by one or more measuring instruments placed in or on the air intake pipe. An external arrangement has proved easy to fit.

### BRIEF DESCRIPTION OF THE DRAWINGS

The invention is explained in further detail with reference to an illustrative embodiment shown in the accompanying drawing FIGURE which is a schematic representation of a centrifugal pump incorporating the apparatus of the invention.

### DETAILED DESCRIPTION OF PREFERRED EMBODIMENTS

The FIGURE shows a centrifugal pump 2 disposed on the floor 1 of a rain overflow basin (not shown in further detail) and having a suction pipe 3 via which the pump sucks up water from the basin. The water pressurized by the centrifugal pump 2 is fed back into the basin via a pipe 4, a cleaning element 5, an injector nozzle 6 and a jet pipe 7. In this process, air is sucked into the injector nozzle 6 via an air intake pipe 8 projecting beyond the highest possible water level of the basin, and is mixed with the conveyed water. A water-air mixture is thus discharged from the jet pipe 7. Alternatively, the air intake pipe can also be supplied via a compressed air source. This can be dependent on the installation and/or system conditions.

Due to the fact that the water present in the rain overflow basin is loaded with impurities, two problem zones for the cleaning system are obtained: these are the intake region 9 at the inlet into the suction pipe 3 and the region in front of the injector nozzle 6. Particularly in the latter region, which forms a considerable constriction, dirt can attach itself, with fibrous components, in particular, tending very easily to get stuck. This can give rise to an increasing blockage, which leads to a deterioration in the aeration and cleaning performance and eventually to a blockage, i.e. a failure of the system.

By a flow sensor 10 which is disposed in the upper region of the air intake pipe 8 and which comprises a sensing element which extends into the air intake pipe 8, the air sucked up through the air intake pipe 8 is measured during system operation. For example, a flow sensor which functions according to the calorimetric principle is suitable, the output signal of which is a measure of the flow velocity of the air brushing past its sensing element and thus of the air quantity sucked up through the air intake pipe 8. Alternatively, a measuring instrument can be used which measures from outside, such as an ultrasound sensor fastened to the air suction pipe line. A measurement value formed from the signal provides information on the flow velocity. From this, the air quantity introduced into the water-air jet generated in the injector nozzle 6 is determinable by the evaluation unit 12. The degree of aeration of the basin cleaning system can be determined by the evaluation unit 12 and indicated on its display. Via a sensor cable 11, the flow sensor 10 relays the respective operating state to an evaluation unit 12 for evaluation of the sensor signals and for their display.

In the event of a blockage within the liquid stream path of the assembly, the air quantity through the air intake pipe 8 which is sucked up during operation becomes less. The evaluation unit 12 then detects a blockage. According to relayed sensor signals, the evaluation unit 12 distinguishes between various operating states such as Satisfactory Operation, Partial Blockage or Operating Disturbance, which evaluation unit indicates these by optical and/or acoustic means. In place of such an evaluation unit 12, any other chosen appliance, for example a computer, may also of course be used.

Since the flow in the air intake pipe 8 is influenced not only by possible blockages at the injector nozzle 6, but by changes within the whole of the delivery area of the centrifugal pump 2, the flow sensor 10 also detects disturbances which occur elsewhere, i.e. in the intake region 9, for example. It is likewise detectable if a flooding of the air intake pipe 8 materializes, as a result of too high a liquid level in the basin.

An inventive arrangement of a flow sensor 10 is not limited to the air intake pipe 8 per se, but is provided, for example, also in air intake regions of the injector nozzle 6. According to the invention, further measuring instruments working according to other measuring principles, such as pressure sensors, may also be used.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

1. An apparatus for monitoring and supporting maintenance of a cleaning or aerating system for a device for receiving and temporarily storing a contaminated liquid, said cleaning or aerating system comprising at least one assembly which sucks up liquid present in the device and discharges the liquid into the device in the form of a jet, and at least one measuring instrument disposed in the vicinity of an air intake pipe for monitoring flow behavior of the liquid.

2. An apparatus as claimed in claim 1, comprising at least one measuring instrument which monitors or measures an air or liquid stream present in the air intake pipe.

3. An apparatus as claimed in claim 1, wherein said measuring instrument comprises at least one sensor disposed in or on the air intake pipe for monitoring or measuring an air stream or a liquid stream.

4. An apparatus as claimed in claim 1, further comprising an evaluation unit which detects and records operating states of the apparatus.

5. A method of monitoring and supporting maintenance of a cleaning or aerating system for a device for receiving and temporarily storing a contaminated liquid, said cleaning or aerating system comprising at least one assembly which sucks up liquid present in the device and discharges the liquid into the device in the form of a jet, said method comprising monitoring flow behavior of the liquid by at least one measuring instrument disposed in the vicinity of an air intake pipe.

6. A method as claimed in claim 5, wherein the measuring instrument monitors or measures an air or liquid stream present in the air intake pipe.

7. A method as claimed in claim 5, wherein the measuring system comprises at least one sensor is disposed in or on the air intake pipe for monitoring or measuring an air stream or a liquid stream.

8. A method as claimed in claim 5, further comprising detecting and recording operating states of the system in an evaluation unit.
